(19) United States
(12) Patent Application Publication
(10) Pub. No.: US 2018/0111535 A1
(43) Pub. Date: Apr. 26, 2018

(54) TEMPERATURE-CONTROLLED BEVERAGE CONTAINER ADAPTED FOR COMPATABILITY WITH AUTOMOTIVE AIR CONDITIONING

(71) Applicant: William Harris, Salt Lake City, UT (US)

(72) Inventor: William Harris, Salt Lake City, UT (US)

(21) Appl. No.: 15/369,771

(22) Filed: Dec. 5, 2016

Related U.S. Application Data
(60) Provisional application No. 62/410,673, filed on Oct. 20, 2016.

(51) Int. Cl. B60N 3/10

(52) U.S. Cl. CPC B60N 3/104

(57) ABSTRACT

An automotive beverage container interconnected with an automotive air conditioning system and power supply to heat and cool a contained beverage to a predetermined temperature.

### CROSS-REFERENCE TO PRIOR APPLICATIONS

This application claims priority to a prior provisional U.S. patent application entitled “Refrigeration and Heating Beverage Container Adapted for Compatability with Automotive Air Conditioning” filed Oct. 20, 2016 for William E. Harris.

### BACKGROUND OF THE INVENTION

### Field of the Invention

This invention relates to automotive cup holders, and more particularly relates to a temperature-controlled cup and container apparatus for heating and refrigerating beverages.

### Description of the Related Art

Automotive cup holders and attachment systems are well-known in the art. In the automotive world, increased sophistication of older technologies is constantly expanding with newer automobiles providing interior features which with superior function, ergonomics and comfort relative to older models, including separate climate controls for various sections of the automobile in an effort to increase interior appeal.

Early automobiles contained no beverage containers. In the 1960s, inclusion of a single beverage container (e.g, “cup holders”) become standard. By the 1980s, multiple cup holders were being included. Today, it is not uncommon for a typical interior automotive design to consist of five or more cup holders recessed into various surfaces of the interior, including center consoles, doors and arms rests. Cup holders in the art also regularly collapse and retract into surfaces, interior compartments, or other automotive fixtures. Some common devices in the art are shown in U.S. Pat. No. 4,733,908 to Dykstra et al, issued Mar. 29, 1988. Many typical beverage containers have been defined by cylindrical recesses in rigid interior components for receiving, and sometimes holding or engaging, portable cylindrical beverage containers of varying radi.

Although these types of beverage container holders have the inherent advantage of simple construction, low cost, the holders available thus far have proven to be unsatisfactory since as they do allow a user to control the temperature of a contained beverage. While providing climate control features for passengers, automobiles have not traditionally been provided with efficient means or refrigerating perishables, or heating or cooling perishables such as beverages.

Americans expend billions of dollars annually at convenience stores only to acquire beverages cooled or heated to a desirable temperature because the current state of the art does not teach efficient means of controlling the temperature of cup holders and/or perishables during transport contained within the automobile. It is desirable, and an object of the present invention, to provide an efficient apparatus, system and method for both heating and cooling a beverage container during transport in an automobile.

### SUMMARY OF THE INVENTION

From the foregoing discussion, it should be apparent that a need exists for an apparatus, system and method of controlling beverage temperature in an automobile during transport. Beneficially, such an apparatus, system and method would overcome many of the difficulties with prior art by providing a means of both heating and cooling the beverage without provision of cumbersome components, such as new compressors.

The present invention has been developed in response to the present state of the art, and in particular, in response to the safety problems and needs in the art that have not yet been fully solved by currently available aparati, systems and methods. Accordingly, the present invention has been developed to provide an automotive beverage container with heating and cooling means, the beverage container comprising: a rigid housing defining a hollow interior recess and one or more open recesses accessible through a top surface of the beverage container for receiving a beverage, the rigid housing forming a receptacle; one or more tubular passageways circumscribing each open recess, the passageways adapted to house a contained evaporation coil connected to an expansion valve on a high side output of a vehicle's refrigerant compressor; one or more 12 volt heating coils circumscribing each open recess; and means for interconnecting the beverage container with a 12 volt electrical system of the an automobile.

The beverage container may further comprise a solenoid valve controlling flow of refrigerant. The beverage container may further comprising a thermometer. The beverage container, in some embodiments, further comprises a thermostat.

The beverage container may further be adapted to interconnect to a low side port. The beverage container may further comprise a high side tap. The beverage container may also further comprise a microprocessor.

The beverage container may further comprise a touch display and virtual controls for adjusting temperature of the beverage container. The beverage container may be configured to: activate a cooling mechanism when a temperature of the beverage container exceeds a predetermined threshold; and activate a heating mechanism when a temperature of the beverage container falls below a second predetermined threshold.

A second automotive beverage container with heating and cooling means is also provided, the beverage container comprising: a rigid housing defining a hollow interior recess and one or more open recesses accessible through a top surface of the beverage container for receiving a beverage, the rigid housing forming a receptacle; one or more 12 volt heating coils circumscribing each open recess; means for interconnecting the beverage container with a 12 volt electrical system of the a vehicle; and one or more tubular passageways circumscribing each open recess, the passageways adapted to couple to an expansion valve affixed to output from a compressor.

A third automotive beverage container with heating and cooling means is provided, the beverage container comprising: a rigid polymeric housing defining a hollow interior recess and one or more open recesses accessible through a top surface of the beverage container for receiving a beverage, the rigid polymeric housing forming a receptacle; one or more 12 volt heating coils circumscribing each open recess; means for interconnecting the beverage container with a 12 volt electrical system of the an automobile; one or more tubular passageways circumscribing each open recess, the passageways adapted to couple to an expansion valve affixed to output from an evaporator interior to the automobile directing air exiting the evaporator through the passageways before input to a compressor; a solenoid valve; a thermometer; a thermostat; a low side tap; a high side tap; and a microprocessor, wherein the beverage container is configured to: activate a cooling mechanism when a temperature of the beverage container exceeds a predetermined threshold; and activate a heating mechanism when a temperature of the beverage container falls below a second predetermined threshold.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a sectioned front side perspective view of temperature-controlled, automotive beverage container adapted to interconnect with an automotive airconditioning in accordance with the present invention;

FIG. 2 is a block diagram of a beverage temperature control system in accordance with the present invention;

FIG. 3 is a schematic illustration of a beverage temperature control system in accordance with the present invention;

FIG. 4 is a schematic illustration of a portion of a beverage temperature control system in accordance with the present invention;

FIG. 5 is a simplified sectioned perspective view of a portion of a temperature-controlled beverage container adapted for compatability with automotive airconditioning in accordance with the present invention;

FIG. 6 is a simplified sectioned perspective view of a portion of a temperature-controlled beverage container adapted for compatability with automotive airconditioning in accordance with the present invention; and

FIG. 7 is a side perspective view of a two-way adapter for a temperature-controlled beverage container adapted for compatability with automotive airconditioning in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

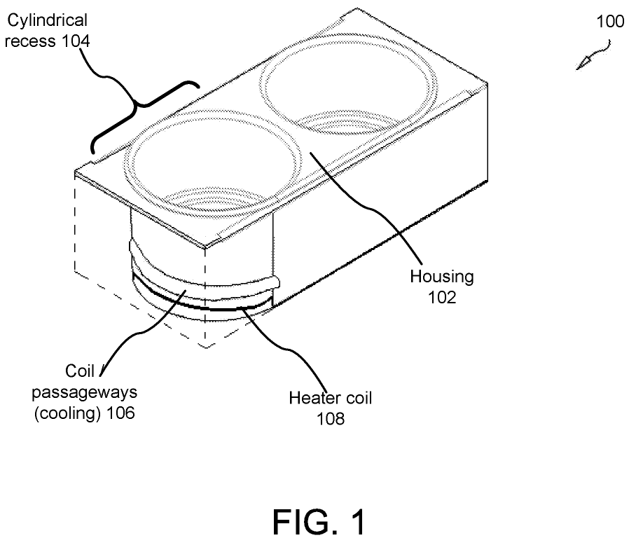

FIG. 1 illustrates a sectioned front side perspective view of temperature-controlled, automotive beverage container 100 adapted to interconnect with automotive airconditioning in accordance with the present invention.

The automotive beverage container 100 comprises a polymeric housing 102 encasing a plurality of cup holders defined by cylindrical recesses 104 recessed into the housing 102. The cup holders may comprise tubular hollow inserts with open top ends for receiving a beverage container such as can, cup or bottle as known to those of skill in the art. The cylindrical recess 104 defined by the cup holder may taper or be non-uniform in diameter.

A plurality of coils 106 circumscribe the cup holder and cylindrical recess 104 for directing the circulation cooled refrigerant from the interconnected automotive compressor around the cup holder. These coils may comprise tubular components or pipes. In other embodiments, these coils comprise passageway, recesses or canals defined by the housing 102 itself and winding around the cylindrical recess 104 helically.

One or more heater coils 108 circumscribe the cylindrical recesses 104. These heating coils may be disposed above or below the coil 106 for conducting heat to the cylindrical recess 104. The coils may wrap around the cup holder in helical fashion.

The automotive beverage container 100 is adapted to cool from the vehicle's existing air conditioning unit and heat a beverage using separate coils 108 interconnected with the vehicle power supply.

The automotive beverage container 100 may be configured to interconnect with an surface of an automotive interior using means known to those of skill in the art, including clipping or affixing to a dashboard, inserted into an existing cup holder in the automobile, and engaging a structural member of the vehicle.

The automotive beverage container 100 is adapted to interconnect with the closed air conditioning circulation system of a vehicle comprising two sides, a high side and a low side. Both sides are connected in accordance with the present invention using a low side port and a high side port when used as an add-on cup cooler/heater vehicle accessory. For factory built vehicles, connection may be made directly to the low and high side tubing.

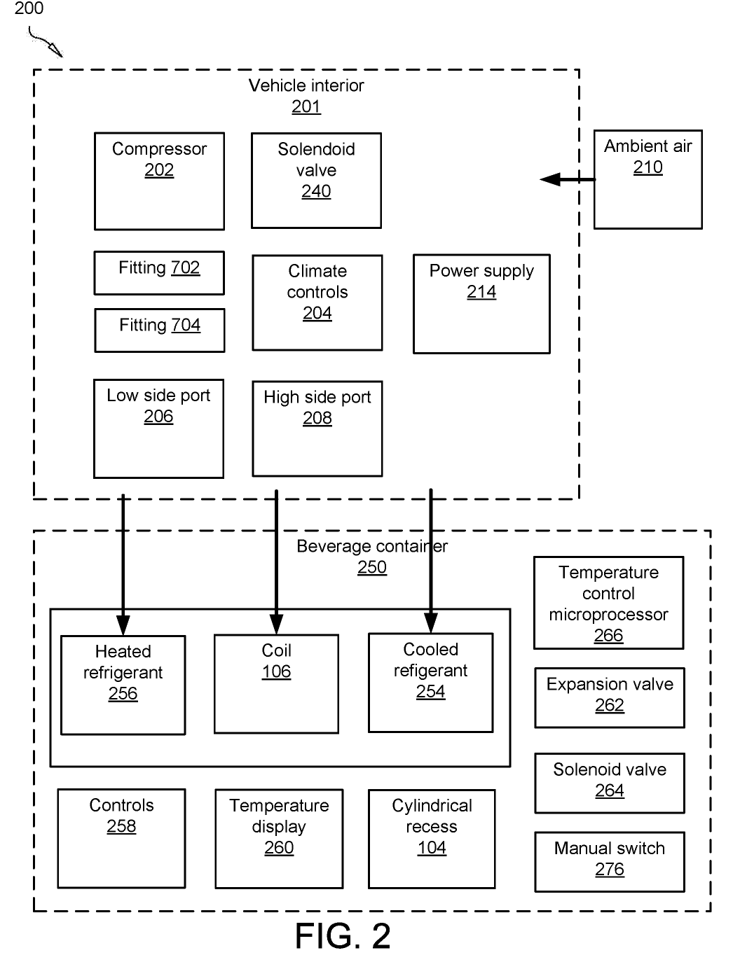

FIG. 2 is a block diagram of a beverage temperature control system 200 in accordance with the present invention. The system 200 comprises a vehicle interior 201 and beverage container 250. The vehicle interior 201 comprises a compressor 202, a solenoid valve 240, climate controls 204, a low side port 206, and a high side port 208, a fitting 702, a fitting 704, and a power supply 214.

The beverage container 250 comprises coils 106 through which cooled refrigerant 254 circulates. The beverage container 250 comprises controls 258, a cylindrical recess 104, a temperature display 260, an expansion valve 262, a solenoid valve 264, and a temperature control microprocessor 266.

The compressor 202 is a pump driven by a belt attached to the engine's crankshaft in most embodiments. When refrigerant is drawn into the compressor, it is in a low-pressure gaseous form. Once the gas is inside the pump, the belt drives the pump, which puts the gas under pressure and forces it into the condenser.

Cooled refrigerant exiting the evaporator is directed into the automotive beverage container 250 through an expansion valve 262.

Coupling or attachment means are integrated into vehicle interior and/or the cup holder for affixation with the low side tap and high side tap of the existing automotive air conditioning system. In various embodiments, the automotive air conditioning system comprises a low side port 206 and a high side port 208 in its stock configuration. In other embodiments, the low side port 206 and a high side port 208 in its stock configuration. For factory-built vehicles, connections may be made directly to the low and high side tubing.

The beverage container 250 comprises the cylindrical recess 104 substantially described above and one or more controls 258 for facilitating user control of beverage temperature. In various embodiments, the control 258 comprise a touch GUI or display which may display virtual controls. The beverage container 250 may also comprise a microprocessor (not shown) for converting input from the controls 258 into electric signals to the one or more electromechanical components of the system 200 for regulating temperature of the beverage container 250.

The temperature control microprocessor 266 is a device which automatically adjusts the temperature to values set by sending or withholding electrical power to the heating and cooling elements. The temperature control microprocessor 266 senses the temperature using a thermocouple adjacent to the cylindrical recess. It also limits the upper temperature of the cup to about 160 degrees Fahrenheit to prevent burn injury. A second microprocessor allows for separate heating and cooling of adjacent cup holders. Housing 102 also comprises insulation between heating coil 108 and the housing surface.

In some embodiments, the microprocessor and temperature controls are separated from the device 100.

The container 250 may comprise a thermostat which automatically regulates temperature or that activates another component in the system 200 and is well-known to those of skill in the art.

The expansion valve 262 comprises a thermal expansion valve which controls the amount of refrigerant flow into an evaporator oil 106 in a beverage container 250.

The solenoid valve 264 is an electromechanically operated valve controlled by an electric current controlled by the microprocessor 266 which switches the coolant flow on or off.

A temperature readout of the cylindrical recess is realized by the microprocessor using means known to those of skill in the art. The thermometer 260 is well-known to those of skill in the art and comprises an instrument for measuring and indicating the temperature of the beverage container 250, and, in some embodiments, relaying a electronic signal representing the temperature to the microprocessor.

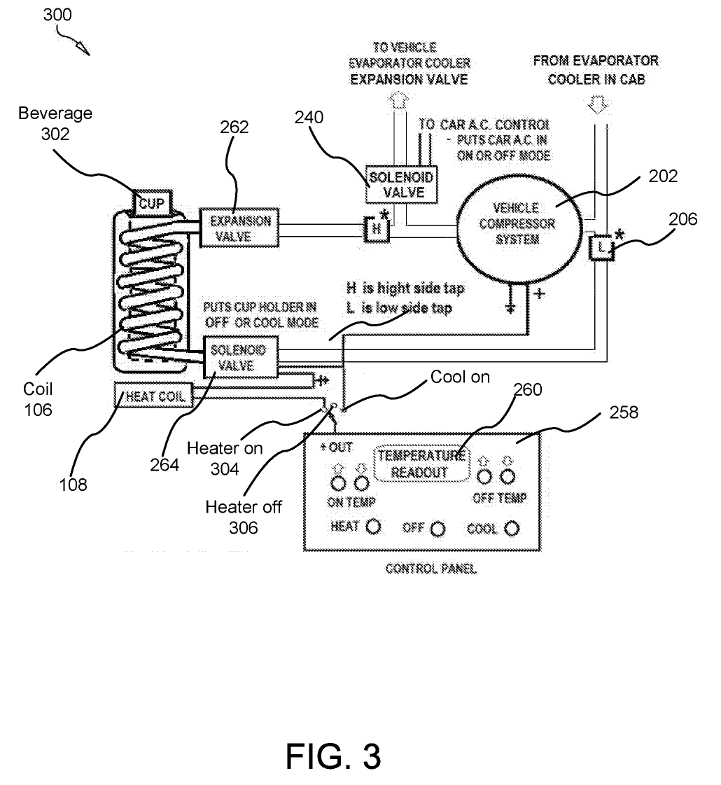

FIG. 3 is a schematic illustration of a beverage temperature control system in accordance with the present invention.

The coils 106 circumscribe the cylindrical recess 104 of the housing 102 and beverage 302 within.

A manual switch between the heater coil 108 and the controls 258 selectively switches from a heater on position 304 to a heater off position 302, applying and stopping electrical current to the heater coil 108. In heating mode, the manual switch may send electrical power to the heater coil 108.

In various embodiments, the controls 258 comprise a microprocess further described above, which is configured to receive temperature signal data from the thermometer 260 and to alternatively activate and deactivate both the heater coils 108 and the

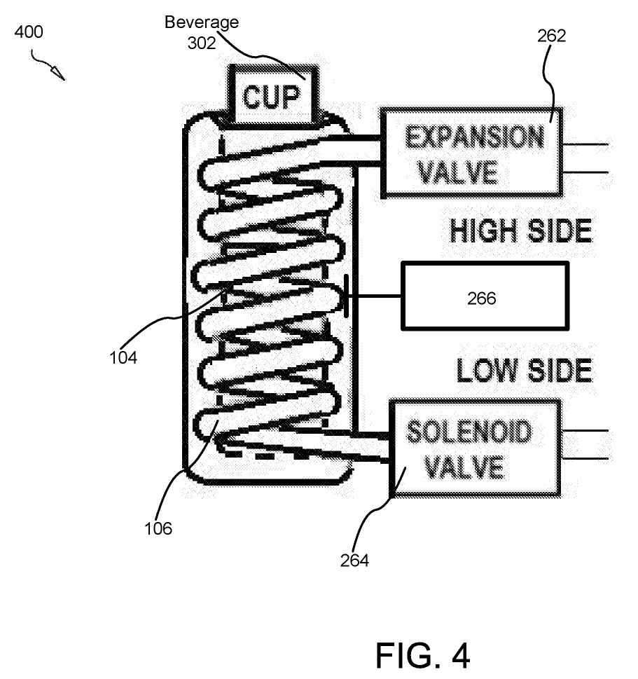

FIG. 4 is a schematic illustration of a portion of a beverage temperature control system 400 in accordance with the present invention. Each of the components shown and labeled in FIG. 4 are housed within the housing 102 and form part of the cooling mechanism of the present invention.

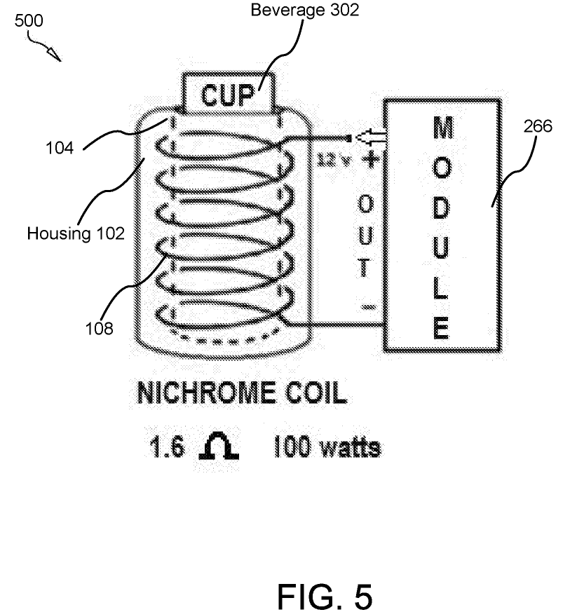

FIG. 5 is a simplified sectioned perspective view of a portion of a temperature-controlled beverage container 500 adapted for compatability with automotive airconditioning in accordance with the present invention.

Each of the components shown and labeled in FIG. 4 are housed within the housing 102 and form part of the heating mechanism of the present invention.

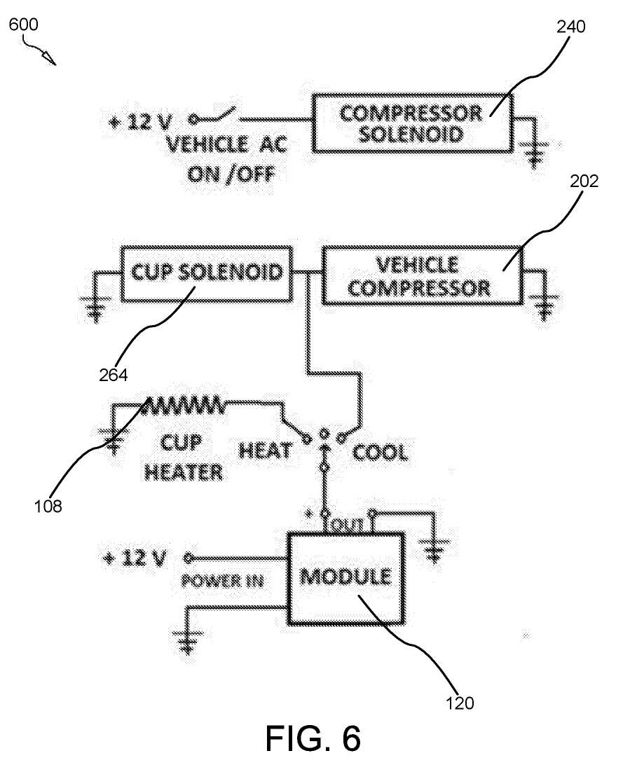

FIG. 6 is a simplified sectioned perspective view of a portion of a temperature-controlled beverage container 600 adapted for compatability with automotive airconditioning in accordance with the present invention.

The device or system 600 comprises a plurality of switches for alternatively activating and deactivating the heating and cooling functions of the beverage 302.

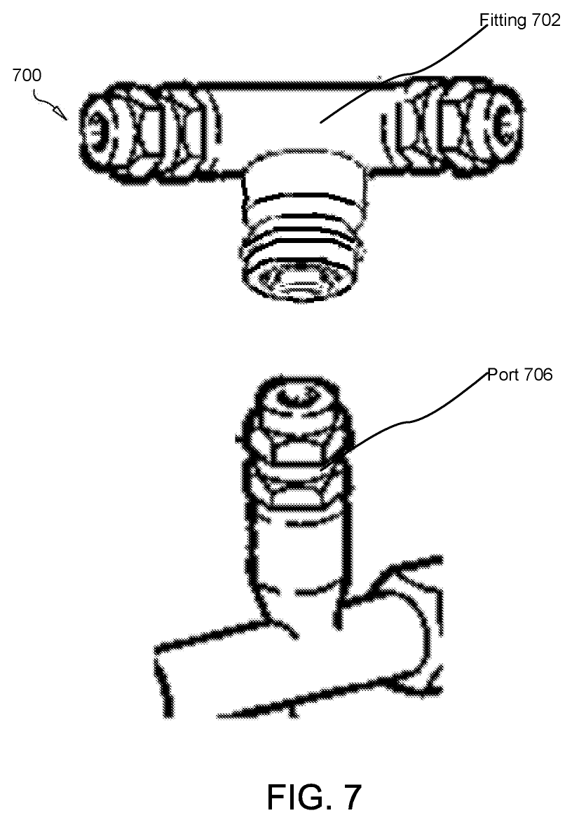

FIG. 7 is a side perspective view of a two-way adapter for a temperature-controlled beverage container adapted for compatability with automotive airconditioning in accordance with the present invention.

The low side and high sides of the automotive air conditioning units may be retrofitted or tapped with service fitting such as service fitting 702 and/or service fitting 704. These service fittings 702, 704 couple with a corresponding fitting on the beverage container 100 such that the beverage container 100 is interconnected with the closed air conditioning system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automotive beverage container with heating and cooling means, the beverage container comprising:
a rigid housing defining a hollow interior recess and one or more open recesses accessible through a top surface of the beverage container for receiving a beverage, the rigid housing forming a receptacle;
one or more tubular passageways circumscribing each open recess, the passageways adapted to house a contained evaporation coil connected to an expansion valve on a high side output of a vehicle's refrigerant compressor;
one or more 12 volt heating coils circumscribing each open recess; and
means for interconnecting the beverage container with a 12 volt electrical system of the an automobile.

2. The beverage container of claim 1, further comprising a solenoid valve controlling flow of refrigerant.

3. The beverage container of claim 1, further comprising a thermometer.

4. The beverage container of claim 1, further comprising a thermostat.

5. The beverage container of claim 1, further adapted to interconnect to a low side port.

6. The beverage container of claim 1, further comprising a high side tap.

7. The beverage container of claim 1, further comprising a microprocessor.

8. The beverage container of claim 1, further comprising a touch display and virtual controls for adjusting temperature of the beverage container.

9. The beverage container of claim 7, wherein the beverage container is configured to:
activate a cooling mechanism when a temperature of the beverage container exceeds a predetermined threshold; and
activate a heating mechanism when a temperature of the beverage container falls below a second predetermined threshold.

10. An automotive beverage container with heating and cooling means, the beverage container comprising:
a rigid housing defining a hollow interior recess and one or more open recesses accessible through a top surface of the beverage container for receiving a beverage, the rigid housing forming a receptacle;
one or more 12 volt heating coils circumscribing each open recess;
means for interconnecting the beverage container with a 12 volt electrical system of the a vehicle; and
one or more tubular passageways circumscribing each open recess, the passageways adapted to couple to an expansion valve affixed to output from a compressor.

11. An automotive beverage container with heating and cooling means, the beverage container comprising:
a rigid polymeric housing defining a hollow interior recess and one or more open recesses accessible through a top surface of the beverage container for receiving a beverage, the rigid polymeric housing forming a receptacle;
one or more 12 volt heating coils circumscribing each open recess;
means for interconnecting the beverage container with a 12 volt electrical system of the an automobile;
one or more tubular passageways circumscribing each open recess, the passageways adapted to couple to an expansion valve affixed to output from an evaporator interior to the automobile directing air exiting the evaporator through the passageways before input to a compressor;
a solenoid valve;
a thermometer;
a thermostat;
a low side port;
a high side port; and
a microprocessor, wherein the beverage container is configured to:
activate a cooling mechanism when a temperature of the beverage container exceeds a predetermined threshold; and
activate a heating mechanism when a temperature of the beverage container falls below a second predetermined threshold.
